(19) United States
(12) Patent Application Publication
(10) Pub. No.: US 2016/0311070 A1
(43) Pub. Date: Oct. 27, 2016

(54) DEVICE AND METHOD FOR REPAIRING A ROTATABLE OBJECT

(71) Applicant: OTIS ELEVATOR COMPANY, Farmington, CT (US)

(72) Inventors: Tahany I. El-WARDANY, Bloomfield, CT (US); Mark S. THOMPSON, Tolland, CT (US)

(21) Appl. No.: 15/103,702

(22) PCT Filed: Dec. 12, 2013
(86) PCT No.: PCT/US2013/074731

§ 371 Date: Jun. 10, 2016

(51) Int. Cl. B23P 6/00; F16H 55/50; B23K 20/00; B21D 3/14; B23K 20/10

(52) U.S. Cl. CPC B23P 6/00; B21D 3/14; B23K 20/103; B23K 20/002; F16H 55/50

(57) ABSTRACT

A device for repairing a rotatable object includes a controller that is selectively operable to send signals to a transducer. The transducer is selectively operable to cause movement of a sonotrode in response to the signals. The device is selectively operable in an ultrasonic welding mode and at least one of a deep rolling mode and an ultrasonic deep rolling mode. A method for repairing a rotatable object involves providing the device; positioning a repair substrate on at least a portion of a rotatable object contact surface of the rotatable object; operating the device in the ultrasonic welding mode to ultrasonically weld the repair substrate to the rotatable object contact surface; and operating the device in at least one of the deep rolling mode and the ultrasonic deep rolling mode to deep roll and/or ultrasonically deep roll the repair substrate to achieve a desired characteristic of the repair substrate.

### BACKGROUND

1. Technical Field.

Aspects of the present invention relate to a device and a method for repairing a rotatable object.

2. Background Information.

Hoisting systems (e.g., elevator systems, crane systems) often include a hoisted object (e.g., an elevator car), a counterweight, a load-bearing member (e.g., a rope, a belt) that connects the hoisted object and the counterweight, and a sheave that contacts the load-bearing member. During operation of such hoisting systems, the sheave can be selectively driven (e.g., by a machine) to selectively move the load-bearing member, which in turn can move the hoisted object and the counterweight. Relative motion between the load-bearing member and the sheave can cause the load-bearing member and/or the sheave to experience wear. Whereas it can be relatively easy and inexpensive to remove and replace the load-bearing member, it can be relatively difficult and expensive to remove and replace the sheave. For example, in some instances in which the hoisting system is within a building, replacement of the sheave can require de-construction of the building, and can require considerable down time for the hoisting system. In such instances, it would be desirable to be able to repair the sheave without having to remove it from the hoisting system. That is, it would be desirable to be able to repair the sheave “in situ”. In previous attempts to solve this problem, devices or methods have been used that involve spraying abrasive powders onto the sheave while the sheave remains within the hoisting system. Such devices and methods can be problematic in that the abrasive powders can be inadvertently dispersed within the hoisting system, and can thereby cause other components of the hoisting system to malfunction. Aspects of the present invention are directed to these and other problems.

### SUMMARY OF ASPECTS OF THE INVENTION

According to an aspect of the present invention, a device for repairing a rotatable object is provided. The device includes a controller that is selectively operable to send signals to a transducer. The transducer is selectively operable to cause movement of a sonotrode in response to signals received from the controller. The device is selectively operable in an ultrasonic welding mode and at least one of a deep rolling mode and an ultrasonic deep rolling mode.

According to another aspect of the present invention, a method for repairing a rotatable object is provided. The rotatable object is selectively rotatable about a rotatable object axis, and the rotatable object has a rotatable object contact surface. The method involves providing a device that includes a controller that is selectively operable to send signals to a transducer, the transducer being selectively operable to cause movement of a sonotrode in response to signals received from the controller, and the device being selectively operable in an ultrasonic welding mode and at least one of a deep rolling mode and an ultrasonic deep rolling mode. The method also involves positioning a repair substrate on at least a portion of the rotatable object contact surface; operating the device in the ultrasonic welding mode to ultrasonically weld the repair substrate to the rotatable object contact surface; and operating the device in at least one of the deep rolling mode and the ultrasonic deep rolling mode to deep roll and/or ultrasonically deep roll the repair substrate to achieve a desired characteristic of the repair substrate.

Additionally or alternatively, the present invention may include one or more of the following features individually or in combination:

in the ultrasonic welding mode, the transducer is selectively operable to cause the sonotrode to ultrasonically oscillate; in the deep rolling mode, the transducer is selectively operable to cause the sonotrode to rotate; and in the ultrasonic deep rolling mode, the transducer is selectively operable to cause the sonotrode to simultaneously rotate and ultrasonically oscillate;

the rotatable object is selectively rotatable about a rotatable object axis, and the rotatable object has a rotatable object contact surface; and the sonotrode is selectively rotatable about a sonotrode axis, and the sonotrode includes a sonotrode contact surface, at least a portion of which is configured to mate with at least a portion of the rotatable object contact surface;

the rotatable object contact surface extends axially between first and second rotatable object face surfaces; the rotatable object axis extends between respective planes defined by the first and second rotatable object face surfaces; and the rotatable object contact surface extends annularly relative to the rotatable object axis;

the rotatable object contact surface defines an annularly-extending groove;

the sonotrode contact surface extends axially between first and second sonotrode face surfaces; the sonotrode axis extends in a direction between respective planes defined by the first and second sonotrode face surfaces; and the sonotrode contact surface extends annularly relative to the sonotrode axis;

at least a portion of the sonotrode contact surface and at least a portion of the rotatable object contact surface have respective shapes that correspond to one another;

the rotatable object contact surface defines an annularly-extending groove; and a shape of the sonotrode contact surface corresponds to a shape of the groove;

the rotatable object is selectively rotatable about a rotatable object axis and the sonotrode is selectively rotatable about a sonotrode axis; and during operation of the device, the device is positioned relative to the rotatable object such that the rotatable object axis and the sonotrode axis are parallel with one another;

in the ultrasonic welding mode, the transducer is selectively operable to cause the sonotrode to ultrasonically oscillate along the sonotrode axis;

in the deep rolling mode, the transducer is selectively operable to cause the sonotrode to rotate about the sonotrode axis;

in the ultrasonic deep rolling mode, the transducer is selectively operable to cause the sonotrode to simultaneously rotate about the sonotrode axis and ultrasonically oscillate along the sonotrode axis;

the sonotrode is selectively rotatable about a sonotrode axis, and the sonotrode includes a sonotrode contact surface that extends annularly about the sonotrode axis; the transducer includes a transducer shaft that is connected to the sonotrode, the transducer shaft extending along and being rotatable about a transducer shaft axis; and the transducer shaft is connected to the sonotrode such that the transducer shaft axis and the sonotrode axis extend along a common axis;

the transducer includes a transducer oscillation mechanism that is selectively operable to ultrasonically oscillate the transducer shaft along the transducer shaft axis, and a transducer rotation mechanism that is selectively operable to rotate the transducer shaft about the transducer shaft axis;

the rotatable object is selectively rotatable about a rotatable object axis; and during operation of the device, device is positioned relative to the rotatable object such that the sonotrode axis and the rotatable object axis extend parallel to one another;

the rotatable object is a sheave of an elevator system;

the sonotrode is interchangeably connected to the transducer;

the device is configured for in situ repair of the rotatable object; and

the sonotrode is selectively rotatable about a sonotrode axis, and the sonotrode includes a sonotrode contact surface that extends annularly about the sonotrode axis, at least a portion of the sonotrode contact surface being configured to mate with at least a portion of the rotatable object contact surface; and during the steps of operating the device, the device is positioned relative to the rotatable object such that the sonotrode contact surface is aligned to mate with at least a portion of the rotatable object contact surface, and such that the sonotrode contact surface additionally applies a radial force on the repair substrate.

These and other aspects of the present invention will become apparent in light of the drawings and detailed description provided below.

### BRIEF DESCRIPTION OF THE DRAWINGS

FIG. 1 illustrates a schematic perspective view of a device disposed relative to a sheave.

FIG. 2 illustrates a partial elevation view of the device and the sheave of FIG. 1.

FIG. 3 illustrates a perspective view of the sonotrode included in the device of FIG. 1.

FIG. 4 illustrates a perspective view of another sonotrode.

FIG. 5 illustrates a perspective view of another sonotrode.

### DETAILED DESCRIPTION

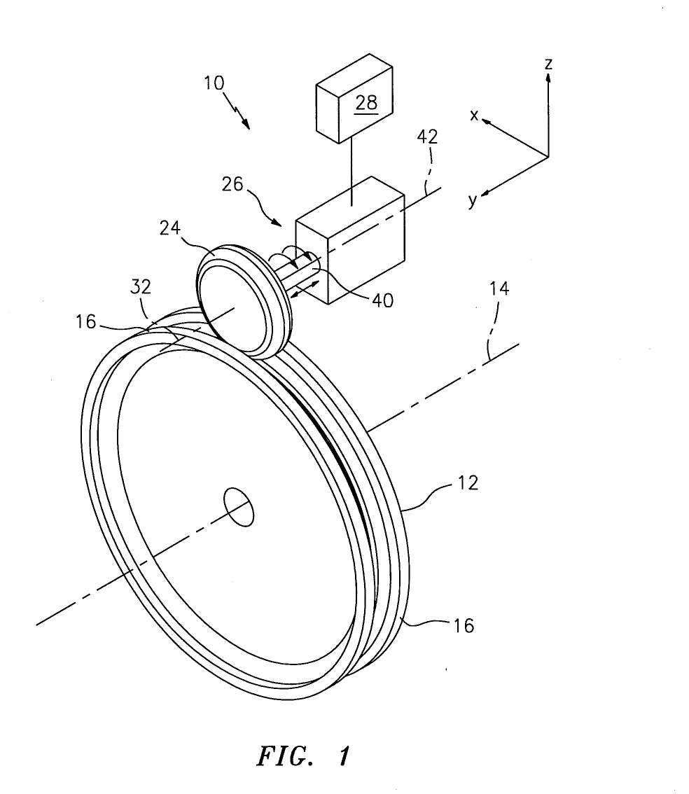

Referring to FIG. 1, the present disclosure describes embodiments of a device 10 and a method for repairing a rotatable object 12. The present disclosure describes aspects of the present invention with reference to the embodiments illustrated in the drawings; however, aspects of the present invention are not limited to the embodiments illustrated in the drawings. The present disclosure may describe one or more features as having a length extending relative to an x-axis, a width extending relative to a y-axis, and/or a height extending relative to a z-axis. The drawings illustrate the respective axes.

The device 10 described herein can be used to repair various types of rotatable objects 12. In the embodiments described herein, the rotatable object 12 is a sheave; however, aspects of the present invention are not limited to use with a rotatable object 12 that is a sheave. For ease of discussion, the rotatable object 12 will hereinafter be referred to as the “sheave 12”. The sheave 12 is selectively rotatable about a sheave axis 14, and the sheave 12 includes a sheave contact surface 16, at least a portion of which is configured to contact another structure (not shown) as the sheave 12 is selectively rotated about the sheave axis 14. In some embodiments, the structure that contacts the sheave contact surface 16 is a load-bearing member (e.g., a rope, a belt, etc.) that is included in a hoisting system (e.g., an elevator system, a crane system, etc.). As will be discussed below, during operation of the device 10, the structure that normally contacts the sheave contact surface 16 is removed or displaced so as to expose for repair at least the portion of the sheave contact surface 16 that is configured to contact the structure.

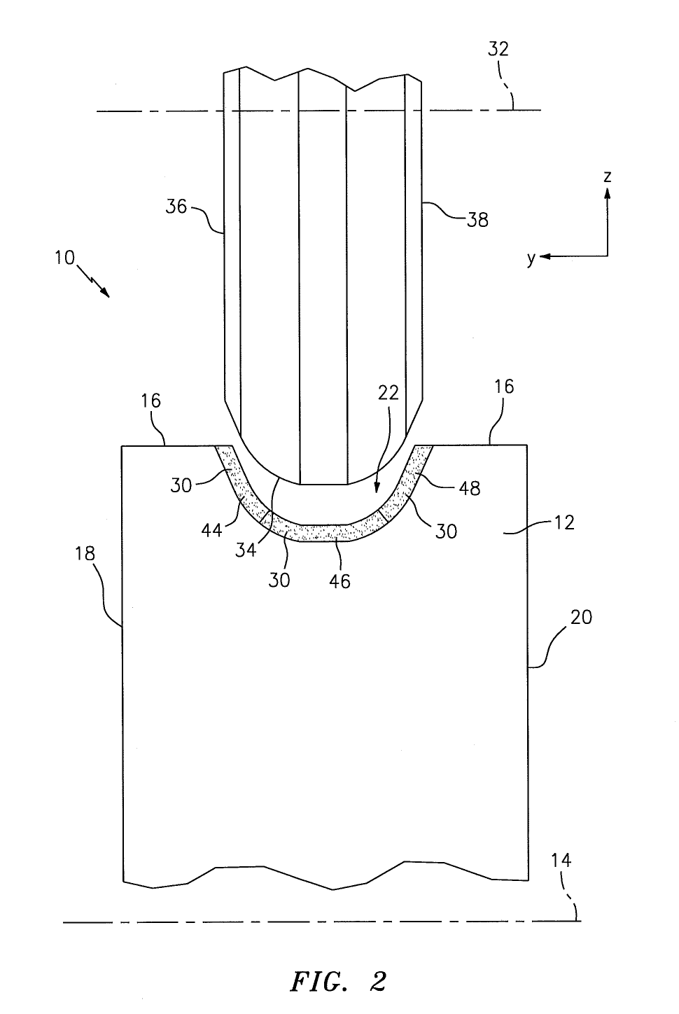

The sheave 12 can have various different configurations. In the embodiment illustrated in FIG. 2, the sheave contact surface 16 extends axially between first and second sheave face surfaces 18, 20 of the sheave 12; the sheave axis 14 extends in a widthwise direction that is generally perpendicular to the respective planes defined by the first and second sheave face surfaces 18, 20; the sheave contact surface 16 extends annularly relative to the sheave axis 14; the sheave contact surface 16 is concentric relative to the sheave axis 14; and the sheave contact surface 16 defines an annularly-extending sheave groove 22 that is configured to contact a load-bearing elevator rope (not shown). In embodiments such as the one illustrated in FIG. 2, in which the sheave contact surface 16 forms a sheave groove 22, the shape of the sheave groove 22 can correspond to the shape of the structure (e.g., the load-bearing elevator rope) that contacts the sheave groove 22. In the embodiment illustrated in FIG. 2, for example, the sheave groove 22 has an arcuate cross-sectional shape that is partially defined by a groove radius, and the groove radius is substantially equal to a rope radius of the load-bearing rope (not shown) that contacts the sheave groove 22 during operation of the sheave 12. The size of the sheave 12 can vary. In the embodiment illustrated in FIG. 2, the diameter of the sheave 12 is approximately one and one half meters (1.5 m). In some embodiments, the diameter of the sheave 12 can be as small as approximately fifteen centimeters (15 cm). The sheave 12 can be made out of various types of materials or combinations of materials. In some embodiments, the one or more materials that form the sheave 12 are selected based on one or more characteristics of the structure (e.g., the load-bearing elevator rope) that contacts the sheave contact surface 16, and/or one or more characteristics (e.g., frictional forces) of the interaction between that structure and the sheave contact surface 16. In the embodiment illustrated in FIG. 2, the sheave 12 is made out of cast iron. In other embodiments, the sheave 12 can additionally or alternatively be made out of ductile iron. In some embodiments, the sheave contact surface 16 is coated with one or more wear resistance materials (e.g., a Stellite® alloy, manufactured by manufactured by Deloro Stellite Holdings Corporation of Goshen, Ind., U.S.A).

Referring to FIG. 1, the device 10 includes a sonotrode 24, a transducer 26, and a controller 28. The controller 28 is selectively operable to send signals to the transducer 26. The transducer 26 is selectively operable to receive the signals from the controller 28, and is selectively operable to cause movement of the sonotrode 24 in response to the signals received from the controller 28. The movement of the sonotrode 24 can vary depending on the mode of operation of the device 10. The device 10 is selectively operable in an ultrasonic welding mode and one or both of a deep rolling mode and an ultrasonic deep rolling (UDR) mode. In the ultrasonic welding mode, the transducer 26 is operable to cause the sonotrode 24 to ultrasonically oscillate. In the deep rolling mode, the transducer 26 is operable to cause the sonotrode 24 to rotate. In the UDR mode, the transducer 26 is operable to cause the sonotrode 24 to simultaneously rotate and ultrasonically oscillate. The ultrasonic welding mode, the deep rolling mode, and the UDR mode will be discussed in more detail below. The device 10 can be used to ultrasonically weld a repair substrate 30 (see FIG. 2) to the sheave contact surface 16 of the sheave 12. The device 10 can then be used to deep roll and/or ultrasonically deep roll the repair substrate 30 to achieve a desired characteristic (e.g., thickness, hardness, fatigue strength, wear resistance, etc.) of the repair substrate 30 and/or the sheave contact surface 16.

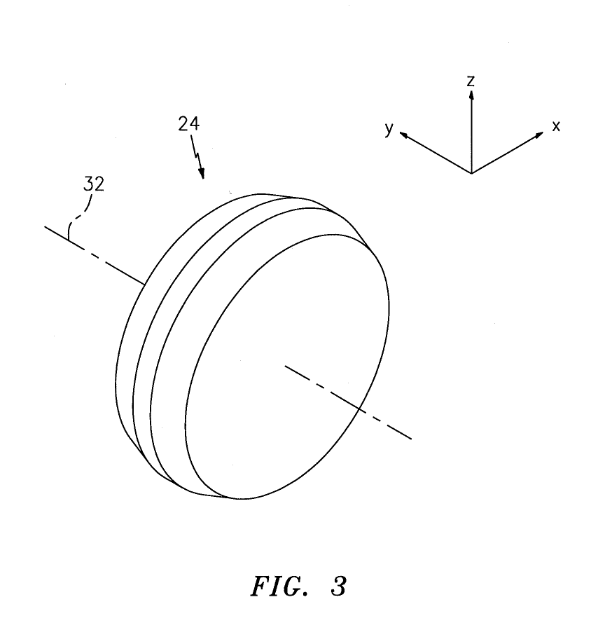

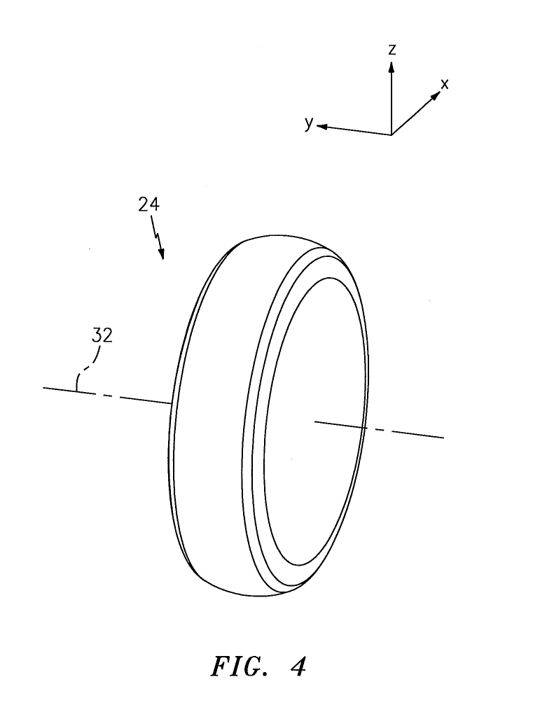

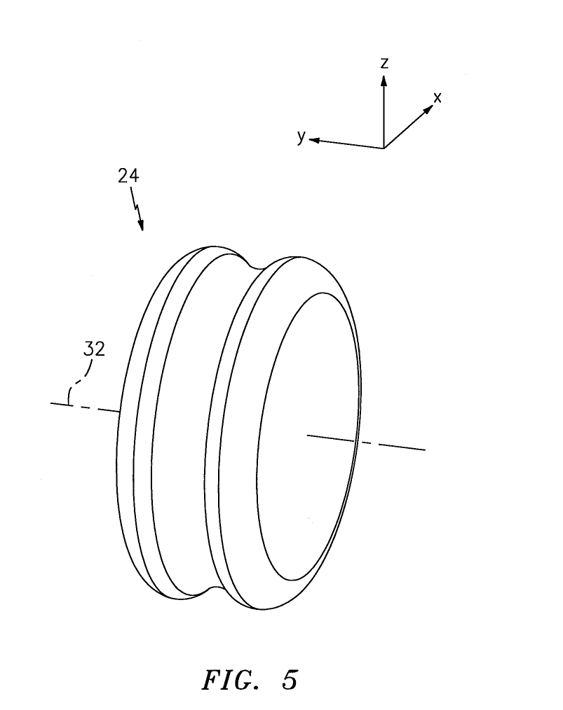

Referring to FIGS. 2-5, the sonotrode 24 is selectively rotatable about a sonotrode axis 32, and the sonotrode 24 includes a sonotrode contact surface 34, at least a portion of which is configured to mate with at least a portion of the sheave contact surface 16. The sonotrode 24 can have various different configurations. In the embodiment illustrated in FIG. 2, the sonotrode contact surface 34 extends axially between first and second sonotrode face surfaces 36, 38 of the sonotrode 24; the sonotrode axis 32 extends in a widthwise direction that is generally perpendicular to the respective planes defined by the first and second sonotrode face surfaces 36, 38; the sonotrode contact surface 34 extends annularly relative to the sonotrode axis 32; and the sonotrode contact surface 34 is concentric relative to the sonotrode axis 32. At least a portion of the sonotrode contact surface 34 and at least a portion of the sheave contact surface 16 have respective shapes that correspond to one another. In the embodiment illustrated in FIG. 2, for example, the shape of the sonotrode contact surface 34 corresponds to the shape of the sheave groove 22. FIGS. 4 and 5 illustrate other sonotrode 24 embodiments that each have a sonotrode contact surface 34 configured to mate with a sheave groove (not shown) that has a different shape than the one shown in FIGS. 2 and 3. The sonotrode 24 can be made out of various types of materials or combinations of materials. In some embodiments, the one or more materials that form the sonotrode 24 are selected based on one or more characteristics (e.g., hardness) of the sheave contact surface 16, and/or one or more characteristics (e.g., malleability, thickness, form, etc.) of the repair substrate 30. In the embodiment illustrated in FIG. 2, the sonotrode 24 is made out of a Stellite® alloy. In other embodiments, the sonotrode 24 can additionally or alternatively include, for example, one or more of the following materials: a steel alloy (e.g., stainless steel, super stainless steel, nanosteel, etc.); an Armacor® alloy manufactured by Liquidmetal Technologies Corporation of Lake Forest, Calif., U.S.A.; a Tribaloy® alloy manufactured by E.I. du Pont de Nemours and Company of Wilmington, Del., U.S.A.; a nickel-chrome-tungsten-boron alloy; and a nickel-boron alloy. In embodiments in which the sonotrode 24 is made of a nickel-boron alloy, the repair substrate 30 can be provided in the form of a sheet that has a thickness that is at least one tenth of a millimeter (0.1 mm), and in some instances has a thickness that is approximately one millimeter (1 mm).

The transducer 26 can have various different configurations. In the embodiment illustrated in FIG. 1, the transducer 26 includes a transducer shaft 40 that is connected to the second sonotrode face surface 38; the transducer shaft 40 extends along and is rotatable about a transducer shaft axis 42; and the transducer shaft 40 is connected to the sonotrode 24 such that the transducer shaft axis 42 and the sonotrode axis 32 extend along the same axis. The transducer 26 can perform the functions described herein in various different ways. In the embodiment illustrated in FIG. 1, the transducer 26 includes a transducer oscillation mechanism (not shown) and a transducer rotation mechanism (not shown). In this embodiment, when the device 10 is operated in the ultrasonic welding mode, the transducer oscillation mechanism ultrasonically oscillates the transducer shaft 40 (and thus the sonotrode 24) along the transducer shaft axis 42 (and thus along the sonotrode axis 32). The phrase “ultrasonically oscillate” and variations thereof are used herein to describe a repetitive back and forth movement having a period that is greater than or equal to approximately twenty kilohertz (20 kHz). In this embodiment, when the device 10 is operated in the deep rolling mode, the transducer rotation mechanism rotates the transducer shaft 40 (and thus the sonotrode 24) relative to the transducer shaft axis 42 (and thus relative to the sonotrode axis 32). In this embodiment, when the device 10 is operated in the UDR mode, the transducer oscillation mechanism ultrasonically oscillates the transducer shaft 40 along the transducer shaft axis 42, and the transducer rotation mechanism simultaneously rotates the transducer shaft 40 relative to the transducer shaft axis 42. In this embodiment, the transducer oscillation mechanism and the transducer rotation mechanism each are implemented using mechanisms that are known in the art.

In some embodiments, the transducer 26 is selectively operable to cause movement of the sonotrode 24 at more than one ultrasonic oscillation frequency and/or more than one rotational velocity. In the embodiment illustrated in FIG. 1, for example, the transducer 26 is selectively operable to increase or decrease the ultrasonic oscillation frequency and/or the rotational velocity in response to a signal received from the controller 28. In some embodiments, including the embodiment illustrated in FIG. 1, the transducer 26 can be configured to ultrasonically oscillate the transducer shaft 40 at a first ultrasonic oscillation frequency when the device 10 is operated in the ultrasonic welding mode, and the transducer 26 can be configured to ultrasonically oscillate the transducer shaft 40 at a different, second ultrasonic oscillation frequency when the device 10 is operated in the UDR mode.

In some embodiments, including the embodiment illustrated in FIG. 1, the transducer 26 can be configured for use with various different sonotrodes 24. In such embodiments, the sonotrode 24 can be interchangeably connected to the transducer 26 (e.g., interchangeably connected to the transducer shaft 40). The sonotrode 24 illustrated in FIG. 1 can be unconnected from the transducer 26 and interchanged with one of the sonotrodes 24 illustrated in FIGS. 4 and 5. This feature can be advantageous because it can permit the device 10 to be used on sheaves 12 having different sheave contact surfaces 16 and different diameters.

In some embodiments, the device 10 can include more than one transducer. For example, in some embodiments not shown in the drawings, the device 10 can include a first transducer that includes a transducer oscillation mechanism, and the device 10 can include a second transducer that includes a transducer rotation mechanism. In such embodiments, the first transducer can include a first transducer shaft that is connected to a first sonotrode face surface; the second transducer can include a second transducer shaft that is connected to the opposing second sonotrode face surface; and the first and second transducer shafts can be connected to the sonotrode 24 such that the first and second transducer shaft axis 42 and the sonotrode axis 32 all extend along the same axis.

The controller 28 is adapted (e.g., programmed) to selectively provide signals to the transducer 26 to cause the transducer 26 to perform one or more of the functions described herein. In some embodiments, the controller 28 can be adapted to selectively provide signals to the transducer 26 in response to a user input. In some embodiments, the controller 28 includes a user interface (e.g., a touch screen, a mechanical switch, etc.) that is operable to receive the user input. The functionality of the controller 28 can be implemented using hardware, software, firmware, or a combination thereof. In some embodiments, for example, the controller 28 can include one or more programmable processors. A person having ordinary skill in the art would be able to adapt (e.g., program) the controller 28 to perform the functionality described herein without undue experimentation. Although the controller 28 is described herein as being separate from the transducer 26, in some embodiments the controller 28 can be implemented as a feature of the transducer 26.

In some embodiments, the device 10 can be relatively compact in comparison to other known devices that are used to repair rotatable objects similar to the sheave 12 illustrated in FIGS. 1 and 2. In some embodiments, the device 10 can be configured for hand held use. In other embodiments, the device 10 can include a mounting structure (not shown) that is operable to position (e.g., fixedly position) the device 10 relative to the sheave 12 during operation of the device 10. In such embodiments, the mounting structure can have various different configurations. For example, in some embodiments in which the device 10 is portable and is used for in situ repair of a sheave 12 that is mounted within an elevator hoistway, the mounting structure can positionally fix the device 10 relative to a portion of the elevator hoistway (e.g., a hoistway wall, a hoistway ceiling, a hoistway floor, etc.). The mounting structure can have various different configurations, and can be implemented using a machine tool post, and/or one or more other structures that are known in the art.

The method for operating the device 10 to repair the sheave 12 includes the steps of: (1) removing or displacing the structure (e.g., the load-bearing elevator rope) that normally contacts the sheave contact surface 16 so as to expose for repair at least the portion of the sheave contact surface 16 that is configured to contact the structure; (2) positioning a repair substrate 30 on at least a portion of the sheave contact surface 16; and (3) using the device 10 to ultrasonically weld the repair substrate 30 to the sheave contact surface 16. The method additionally includes one or both of the following steps: (4) using the device 10 to deep roll the repair substrate 30 to achieve a desired characteristic (e.g., thickness, hardness, fatigue strength, wear resistance, etc.) of the repair substrate 30 and/or the sheave contact surface 16; and (5) using the device 10 to ultrasonically deep roll the repair substrate 30 to achieve a desired characteristic (e.g., thickness, hardness, fatigue strength, wear resistance, etc.) of the repair substrate 30 and/or the sheave contact surface 16.

Regarding the second step of the method, the repair substrate 30 can be made out of various types of materials or combinations of materials. In some embodiments, the one or more materials that form the repair substrate 30 are selected to correspond to one or more materials of the sheave 12. In the embodiment illustrated in FIG. 2, the repair substrate 30 is made out of a Stellite® alloy. The repair substrate 30 can be provided in various forms. In the embodiment illustrated in FIG. 2, the repair substrate 30 is provided in the form a metallic foil. In other embodiments, the repair substrate 30 can be provided in the form of a tape and/or a sheet. The repair substrate 30 can be provided in various shapes and sizes. In some embodiments, the repair substrate 30 is provided in one continuous piece that covers the entire sheave contact surface 16. In other embodiments, the repair substrate 30 is segmented (e.g., axially segmented, circumferentially segmented, etc.) into a plurality of discrete pieces, and/or the repair substrate 30 is positioned on only a portion of the sheave contact surface 16 (e.g., the sheave groove 22). In the embodiment illustrated in FIG. 2, for example, the repair substrate 30 is axially segmented into three discrete pieces 44, 46, 48 that each extend annularly around the sheave contact surface 16. In this embodiment, the repair substrate 30 is positioned on only the sheave groove 22 portion of the sheave contact surface 16. The thickness of the repair substrate 30 can vary depending on a size of the sheave 12 (e.g., the diameter of the sheave 12), a shape of the sheave 12 (e.g., a shape of a sheave groove 22), and/or the amount of wear that has occurred on the sheave contact surface 16. In this embodiment, the repair substrate 30 has a radially-extending thickness that is approximately one tenth of a millimeter (0.1 mm). In other embodiments, the repair substrate 30 can have a radially-extending thickness that is greater than or less than one tenth of a millimeter (0.1 mm).

Regarding the third, fourth, and fifth steps of the method, these steps can be performed by operating the device 10 in the ultrasonic welding mode, the deep rolling mode, and the UDR mode, respectively. During these steps, the device 10 is positioned relative to the sheave 12 such that the sonotrode contact surface 34 is aligned to mate with at least a portion of the sheave contact surface 16 (shown in FIG. 2); and is positioned such that the sonotrode contact surface 34 applies a radial force (e.g., a static radial force) on the repair substrate 30 (not shown in FIG. 2). FIG. 2 illustrates the device 10 positioned relative to the sheave 12 such that the sonotrode contact surface 34 is aligned to mate with the sheave groove 22. In FIG. 2, the sheave axis 14 and the sonotrode axis 32 are parallel and are disposed within the same y-z plane. In the embodiment illustrated in FIG. 2, the sonotrode 24 would be moved in a downward heightwise direction to apply a radial force on the repair substrate 30. The radial force applied on the repair substrate 30 by the sonotrode 24 during the steps can vary. In some embodiments, the radial force can be up to approximately two thousand Newtons (2000 N) during the third step of the method; the radial force can be up to approximately three thousand five hundred Newtons (3500 N) during the fourth step of the method; and the radial force can be up to approximately eight hundred Newtons (800 N) during the fifth step of the method. The radial force applied on the repair substrate 30 by the sonotrode 24 can cause the sonotrode 24 to “penetrate” the repair substrate 30 and/or the underlying sheave contact surface 16 by a penetration depth (e.g., 10 μm, 20 μm, 30 μm, 40 μm, etc.). In some embodiments, the controller 28 is operable to selectively adjust the radial force applied by the sonotrode contact surface 34 on the repair substrate 30. In some embodiments, the controller 28 is operable to selectively adjust the radial force applied by the sonotrode contact surface 34 on the repair substrate 30 to achieve and maintain a predetermined penetration depth. In some instances, the controller 28 works in conjunction with a feeding table (not shown) to maintain the predetermined penetration depth. In the plane perpendicular to the radial force, the magnitude of forces applied by the sonotrode contact surface 34 on the repair substrate 30 can be relatively very small, and the coefficient of friction at the interface between the sonotrode contact surface 34 on the repair substrate 30 can be less than eight one hundredths (0.08), even when the interface is dry.

Regarding the fourth and fifth steps of the method, these steps involve rotation of the sonotrode 24 about the sonotrode axis 32. During performance of these steps, the sheave 12 can be actively rotated about the sheave axis 14 in a direction (e.g., a clockwise direction, a counter-clockwise direction) that is same as the direction of rotation of the sonotrode 24, or the sheave 12 can be actively rotated about the sheave axis 14 in a direction that is opposite to the direction of rotation of the sonotrode 24. In some embodiments, these steps can involve one or two full rotations of the sheave 12 about the sheave axis 14.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, features disclosed in connection with one embodiment can be used alone or in combination with features of one or more other embodiments.

What is claimed is:

1. A device for repairing a rotatable object, the device comprising:
a controller that is selectively operable to send signals to a transducer, the transducer being selectively operable to cause movement of a sonotrode in response to signals received from the controller;
wherein the device is selectively operable in an ultrasonic welding mode at least one of a deep rolling mode and an ultrasonic deep rolling mode.

2. The device of claim 1, wherein in the ultrasonic welding mode, the transducer is selectively operable to cause the sonotrode to ultrasonically oscillate;
wherein in the deep rolling mode, the transducer is selectively operable to cause the sonotrode to rotate; and
wherein in the ultrasonic deep rolling mode, the transducer is selectively operable to cause the sonotrode to simultaneously rotate and ultrasonically oscillate.

3. The device of claim 1, wherein the rotatable object is selectively rotatable about a rotatable object axis, and the rotatable object has a rotatable object contact surface; and
wherein the sonotrode is selectively rotatable about a sonotrode axis, and the sonotrode includes a sonotrode contact surface, at least a portion of which is configured to mate with at least a portion of the rotatable object contact surface.

4. The device of claim 3, wherein the rotatable object contact surface extends axially between first and second rotatable object face surfaces; the rotatable object axis extends between respective planes defined by the first and second rotatable object face surfaces; and the rotatable object contact surface extends annularly relative to the rotatable object axis.

5. The device of claim 4, wherein the rotatable object contact surface defines an annularly-extending groove.

6. The device of claim 3, wherein the sonotrode contact surface extends axially between first and second sonotrode face surfaces; the sonotrode axis extends in a direction between respective planes defined by the first and second sonotrode face surfaces; and the sonotrode contact surface extends annularly relative to the sonotrode axis.

7. The device of claim 6, wherein at least a portion of the sonotrode contact surface and at least a portion of the rotatable object contact surface have respective shapes that correspond to one another.

8. The device of claim 7, wherein the rotatable object contact surface defines an annularly-extending groove; and
wherein a shape of the sonotrode contact surface corresponds to a shape of the groove.

9. The device of claim 1, wherein the rotatable object is selectively rotatable about a rotatable object axis and the sonotrode is selectively rotatable about a sonotrode axis; and
wherein during operation of the device, the device is positioned relative to the rotatable object such that the rotatable object axis and the sonotrode axis are parallel with one another.

10. The device of claim 9, wherein in the ultrasonic welding mode, the transducer is selectively operable to cause the sonotrode to ultrasonically oscillate along the sonotrode axis.

11. The device of claim 9, wherein in the deep rolling mode, the transducer is selectively operable to cause the sonotrode to rotate about the sonotrode axis.

12. The device of claim 9, wherein in the ultrasonic deep rolling mode, the transducer is selectively operable to cause the sonotrode to simultaneously rotate about the sonotrode axis and ultrasonically oscillate along the sonotrode axis.

13. The device of claim 1, wherein the sonotrode is selectively rotatable about a sonotrode axis, and the sonotrode includes a sonotrode contact surface that extends annularly about the sonotrode axis;
wherein the transducer includes a transducer shaft that is connected to the sonotrode, the transducer shaft extending along and being rotatable about a transducer shaft axis; and
wherein the transducer shaft is connected to the sonotrode such that the transducer shaft axis and the sonotrode axis extend along a common axis.

14. The device of claim 13, wherein the transducer includes a transducer oscillation mechanism that is selectively operable to ultrasonically oscillate the transducer shaft along the transducer shaft axis, and a transducer rotation mechanism that is selectively operable to rotate the transducer shaft about the transducer shaft axis.

15. The device of claim 13, wherein the rotatable object is selectively rotatable about a rotatable object axis; and
wherein during operation of the device, device is positioned relative to the rotatable object such that the sonotrode axis and the rotatable object axis extend parallel to one another.

16. The device of claim 1, wherein the rotatable object is a sheave of an elevator system.

17. The device of claim 1, wherein the sonotrode is interchangeably connected to the transducer.

18. The device of claim 1, wherein the device is configured for in situ repair of the rotatable object.

19. A method for repairing a rotatable object, the rotatable object being selectively rotatable about a rotatable object axis, and the rotatable object having a rotatable object contact surface, the method comprising:
providing a device that includes a controller that is selectively operable to send signals to a transducer, the transducer being selectively operable to cause movement of a sonotrode in response to signals received from the controller, and the device being selectively operable in an ultrasonic welding mode and at least one of a deep rolling mode and an ultrasonic deep rolling mode;
positioning a repair substrate on at least a portion of the rotatable object contact surface;
operating the device in the ultrasonic welding mode to ultrasonically weld the repair substrate to the rotatable object contact surface; and
operating the device in at least one of the deep rolling mode and the ultrasonic deep rolling mode to deep roll and/or ultrasonically deep roll the repair substrate to achieve a desired characteristic of the repair substrate.

20. The method of claim 19, wherein the rotatable object is a sheave of an elevator system.

21. The device of claim 19, wherein in the ultrasonic welding mode, the transducer is selectively operable to cause the sonotrode to ultrasonically oscillate;
wherein in the deep rolling mode, the transducer is selectively operable to cause the sonotrode to rotate; and
wherein in the ultrasonic deep rolling mode, the transducer is selectively operable to cause the sonotrode to simultaneously rotate and ultrasonically oscillate.

22. The method of claim 21, wherein the sonotrode is selectively rotatable about a sonotrode axis, and the sonotrode includes a sonotrode contact surface that extends annularly about the sonotrode axis, at least a portion of the sonotrode contact surface being configured to mate with at least a portion of the rotatable object contact surface; and
wherein during the steps of operating the device, the device is positioned relative to the rotatable object such that the sonotrode contact surface is aligned to mate with at least a portion of the rotatable object contact surface, and such that the sonotrode contact surface additionally applies a radial force on the repair substrate.
